(19) United States
(12) Patent Application Publication
(10) Pub. No.: US 2006/0138695 A1
(43) Pub. Date: Jun. 29, 2006

(54) Method for manufacturing decorative articles

(76) Inventor: Kuo-Chih Lee, Kaohsiung City (TW)

Correspondence Address: LAW OFFICES OF ALBERT WAI-KIT CHAN, LLC, WORLD PLAZA, SUITE 604, 141-07 20TH AVENUE, WHITESTONE, NY, 11357, US

(21) Appl. No.: 11/022,913

(22) Filed: Dec. 27, 2004

(51) Int. Cl. B29C 33/40

(52) U.S. Cl. 264/219; 264/245

(57) ABSTRACT

A method for manufacturing a decorative article includes: preparing a metal mold defining a cavity and a pattern of separated recesses disposed within the cavity; filling the cavity and the recesses in the metal mold with a silicone rubber so as to form a silicone mold; filling the silicone mold with a first molding material, and curing the first molding material so as to form a base that defines a pattern of decorating recesses; and filling the decorating recesses in the base with a second molding material, and curing the second molding material so as to form a pattern of decorative elements in the decorating recesses in the base.

### BACKGROUND OF THE INVENTION

1. Field of the Invention

This invention relates to a method for manufacturing decorative articles, more particularly to a method for manufacturing decorative articles by using a silicone mold.

2. Description of the Related Art

Conventionally, decorative articles are essentially made from plastic materials that are harmful to the environment and that are not recyclable. Manufacture of the conventional decorative articles begins with preparing a plurality of copper molds, each of which defines a desired pattern, and a molding mixture including the aforesaid plastic materials and a pigment powder or paste. The molding mixture is subsequently fed into each copper mold in small amounts. The copper molds are heated to cure the molding mixture therein, so as to form the decorative articles.

Since the mass-production of the conventional decorative articles involves use of many copper molds, the production cost is relatively high. Moreover, since the molding mixture used for preparing the conventional decorative articles includes the aforesaid plastic materials, the decorative articles thus made tend to have an adverse impact upon the environment.

### SUMMARY OF THE INVENTION

Therefore, the object of the present invention is to provide a method for manufacturing a decorative article that is clear of the aforesaid drawbacks of the prior art.

According to this invention, a method for manufacturing a decorative article includes (a) preparing a metal mold defining a cavity and a pattern of separated recesses disposed within the cavity, (b) filling the cavity and the recesses in the metal mold with a silicone rubber so as to form a silicone mold that defines a pattern of protrusions corresponding respectively to the recesses, and a pattern of grooves among the protrusions, (c) filling the silicone mold with a first molding material selected from the group consisting of polyurethane resins, epoxy resins and mixtures thereof, and curing the first molding material so as to form a base that defines a pattern of decorating recesses which correspond respectively to the protrusions of the silicone mold, and (d) filling the decorating recesses in the base with a second molding material selected from the group consisting of polyurethane resins, epoxy resins and mixtures thereof, and curing the second molding material so as to form a pattern of decorative elements in the decorating recesses in the base.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a flow diagram to illustrate consecutive steps of the preferred embodiment of a method for manufacturing a decorative article according to this invention;

FIGS. 2 and 3 respectively are perspective and sectional views to illustrate a metal mold used in the preferred embodiment;

FIG. 4 is a schematic view to illustrate a silicone mold prepared in the preferred embodiment;

FIG. 5 is a schematic view to illustrate a base prepared in the preferred embodiment;

FIG. 6 is a perspective view to illustrate a decorative article manufactured according to the preferred embodiment;

FIG. 7 is a perspective view to illustrate a base having a configuration different from that of the base shown in FIG. 5; and

FIG. 8 is a perspective view to illustrate a decorative article formed with the base shown in FIG. 7.

### DETAILED DESCRIPTION OF THE PREFERRED EMBODIMENT

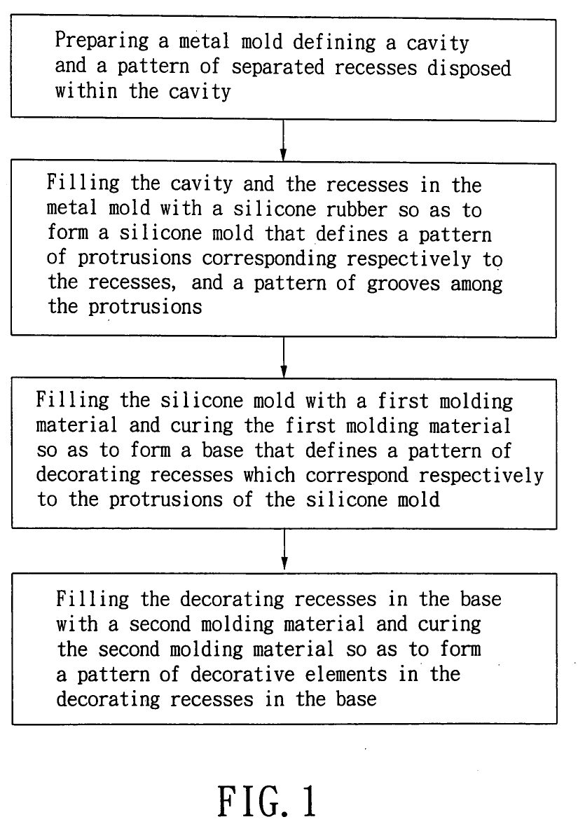

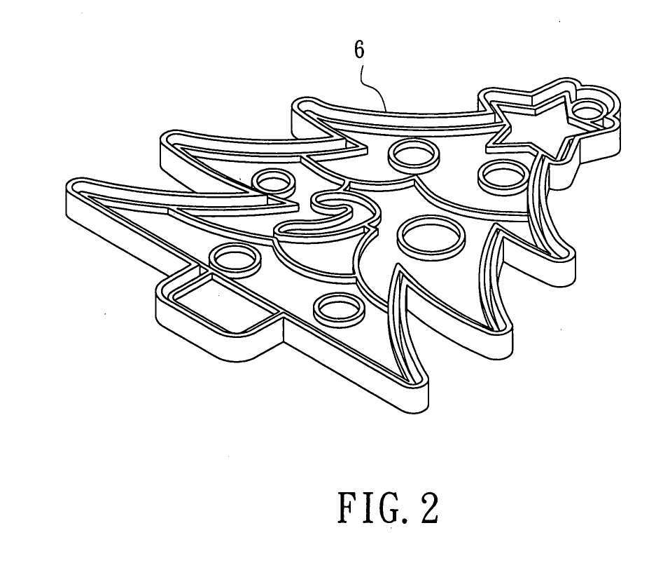

Referring to FIGS. 1, 2 and 3, the preferred embodiment of a method for manufacturing a decorative article according to this invention involves preparation of a metal mold 6. The metal mold 6 defines a cavity and a pattern of separated recesses disposed within the cavity. Preferably, the metal mold 6 is a copper mold.

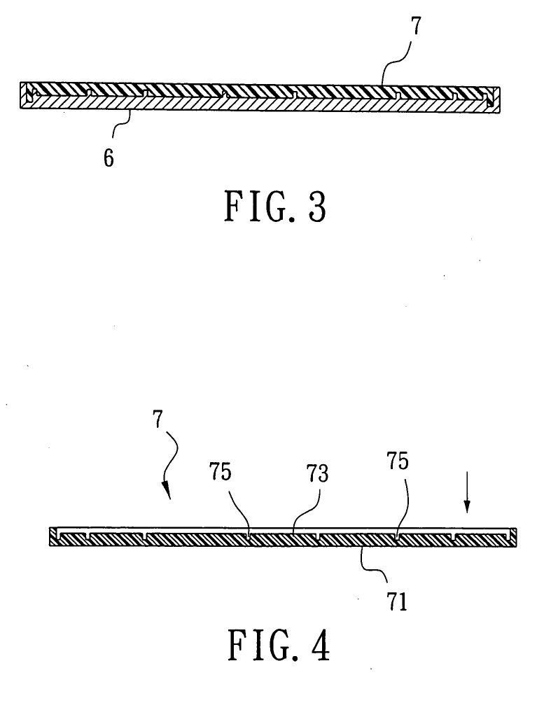

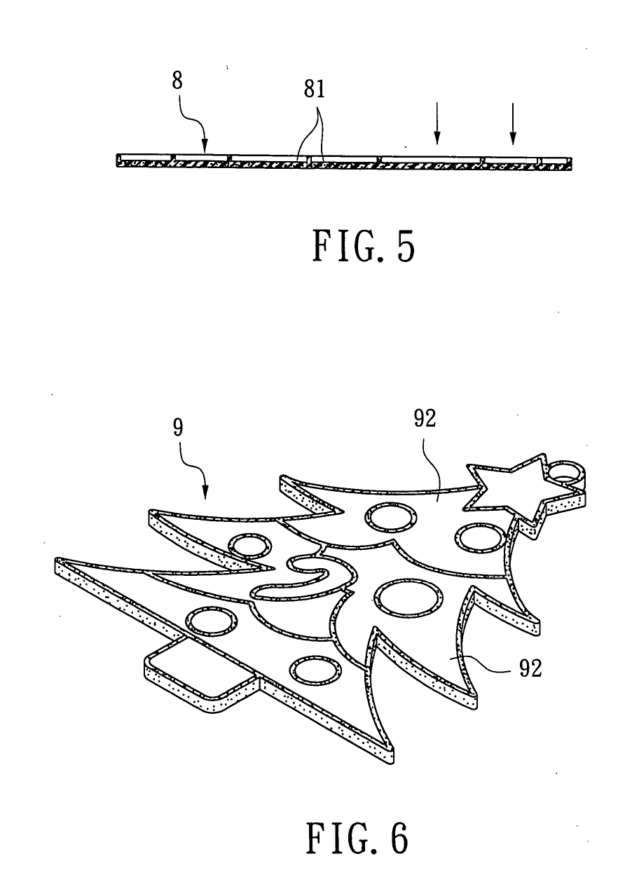

Referring to FIGS. 3 and 4, the cavity and the recesses of the metal mold 6 are filled with a silicone rubber so as to form a silicone mold 7. The silicone mold 7 has a bottom plate 71, and defines a pattern of protrusions 73 that protrude from the bottom plate 71 and that correspond respectively to the recesses in the metal mold 6, and a pattern of grooves 75 among the protrusions 73 of the silicone mold 7.

Next, the silicone mold 7 is filled with a first molding material that is subsequently cured so as to form a base 8 that defines a pattern of decorating recesses 81 which correspond respectively to the protrusions 73 of the silicone mold 7. Preferably, the first molding material is selected from the group consisting of polyurethane resins, epoxy resins and mixtures thereof. In addition, the curing operation of the first molding material is preferably conducted at a temperature ranging from 110° C. to 130° C. for 10 minutes to 20 minutes.

The decorating recesses 81 in the base 8 removed from the silicone mold 7 are subsequently filled with a second molding material. Preferably, the second molding material is selected from the group consisting of polyurethane resins, epoxy resins and mixtures thereof. Referring to FIG. 6, the second molding material in the decorating recesses 81 in the base 8 is cured so as to form a pattern of decorative elements 92 in the decorating recesses 81 in the base 8. The decorative elements 92 and the base 8 are bonded together to form a decorative article 9. In addition, the curing operation of the second molding material is preferably conducted at a temperature ranging from 90° C. to 110° C. for 25 minutes to 35 minutes.

More preferably, each of the first and second molding materials further includes an additive selected from the group consisting of a pigment powder and a pigment paste in such a manner that the first molding material has a color different from that of the second molding material.

Alternatively, the decorative recesses 81 in the base 8 can be filled with a plurality of second molding materials including different pigment powders or pastes so as to form a color pattern of decorative elements 92.

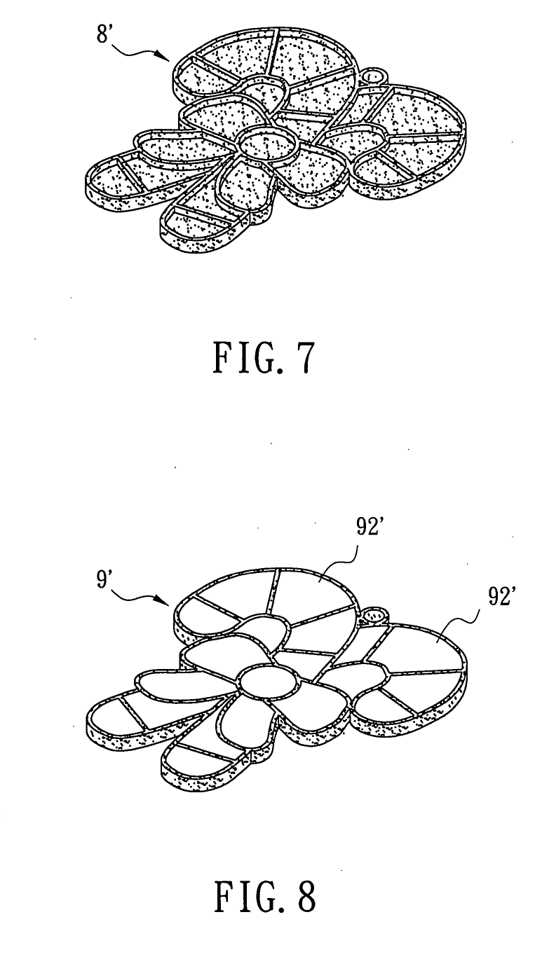

Referring to FIG. 7, the base 8′ is shown to have a configuration different from that of the base 8 of FIG. 6. The decorative article 9′, that is prepared using the base 8′ and that includes decorative elements 92′, is shown in FIG. 8.

According to the method of this invention, the decorative articles 9, 9′ can be mass-produced by forming a plurality of the silicone molds 7 from a single metal mold 6 so that the production cost can be reduced. In addition, since the first and second molding materials of this invention are recyclable and pollution-free materials, environmental concerns can be avoided.

While the present invention has been described in connection with what is considered the most practical and preferred embodiment, it is understood that this invention is not limited to the disclosed embodiments but is intended to cover various arrangements included within the spirit and scope of the broadest interpretation and equivalent arrangements.

What is claimed is:

1. A method for manufacturing a decorative article, comprising:
(a) preparing a metal mold defining a cavity and a pattern of separated recesses disposed within the cavity;
(b) filling the cavity and the recesses in the metal mold with a silicone rubber so as to form a silicone mold that defines a pattern of protrusions corresponding respectively to the recesses, and a pattern of grooves among the protrusions;
(c) filling the silicone mold with a first molding material selected from the group consisting of polyurethane resins, epoxy resins and mixtures thereof, and curing the first molding material so as to form a base that defines a pattern of decorating recesses which correspond respectively to the protrusions of the silicone mold; and
(d) filling the decorating recesses in the base with a second molding material selected from the group consisting of polyurethane resins, epoxy resins and mixtures thereof, and curing the second molding material so as to form a pattern of decorative elements in the decorating recesses in the base.

2. The method as claimed in claim 1, wherein each of the first and second molding materials comprises an additive selected from the group consisting of a pigment powder and a pigment paste in such a manner that the first molding material has a color different from that of the second molding material.

3. The method as claimed in claim 1, wherein the curing of the first molding material is conducted at a temperature ranging from 110° C. to 130° C. for 10 minutes to 20 minutes.

4. The method as claimed in claim 1, wherein the curing of the second molding material is conducted at a temperature ranging from 90° C. to 110° C. for 25 minutes to 35 minutes.
